(19) United States
(12) Patent Application Publication
(10) Pub. No.: US 2016/0350610 A1
(43) Pub. Date: Dec. 1, 2016

(54) USER RECOGNITION METHOD AND DEVICE

(71) Applicant: Samsung Electronics Co., Ltd., Suwon-si (KR)

(72) Inventors: Byung In YOO, Suwon-si (KR); Won Jun KIM, Suwon-si (KR); Jae Joon HAN, Suwon-si (KR)

(73) Assignee: Samsung Electronics Co., Ltd., Suwon-si (KR)

(21) Appl. No.: 15/234,457

(22) Filed: Aug. 11, 2016

Related U.S. Application Data
(63) Continuation of application No. PCT/KR2014/003922, filed on May 2, 2014.

(30) Foreign Application Priority Data
Mar. 18, 2014 (KR) 10-2014-0031780

(51) Int. Cl. G06K 9/00; G10L 17/00; G06K 9/66; G06K 9/46; G06K 9/62

(52) U.S. Cl. CPC G06K 9/00892; G06K 9/00369; G06K 9/4652; G06K 9/6215; G06K 9/66; G06K 9/00348; G10L 17/005

(57) ABSTRACT

A user recognition method includes extracting a user feature of a current user from input data, estimating an identifier of the current user based on the extracted user feature, and generating the identifier of the current user in response to an absence of an identifier corresponding to the current user and controlling an updating of user data based on the generated identifier and the extracted user feature.

### CROSS-REFERENCE TO RELATED APPLICATIONS

This application is a continuation of International Application No. PCT/KR2014/003922 filed on May 2, 2014, which claims the benefit of Korean Patent Application No. 10-2014-0031780 filed on Mar. 18, 2014, in the Korean Intellectual Property Office, the entire disclosures of which are incorporated herein by reference for all purposes.

### BACKGROUND

1. Field

Example embodiments relate to user recognition technology that may recognize a user based on image data and audio data.

2. Description of Related Art

User recognition systems are automated hardware particularly implemented with computing technologies to recognize a user, such as through respective use of bioinformation, or biometrics, for example, a user recognition system may be configured to recognize a user based on a detected face, a user recognition system may be configured to recognize a user based on a detected fingerprint, a user recognition system may be configured to recognize a user based on a detected iris of a user, or a user recognition system may be configured to recognize a user based on a detected voice of a user. The user recognition system may determine a user by comparing bioinformation input at an initial setting process to recognized similar bioinformation, for example by comparing a detected face image to stored face images or by comparing a detected fingerprint to stored fingerprints. The user recognition system may recognize a user mainly using prestored bioinformation in a restricted space, such as, for example, a home or an office, and may register therein bioinformation of a new user when the new user is added. However, such user recognition systems suffer from technological problems that may prevent accurate or sufficiently efficient user recognitions for the underlying authorization purposes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a user recognition method includes extracting a user feature of a current user from input data, estimating an identifier of the current user based on the extracted user feature, and generating the identifier of the current user in response to an absence of an identifier corresponding to the current user and controlling an updating of user data based on the generated identifier and the extracted user feature.

The estimating of the identifier of the current user may include determining a similarity between the current user and an existing user included in the user data based on the extracted user feature, and determining whether an identifier corresponding to the current user present is based on the determined similarity.

The updating of the user data may include performing unsupervised learning based on the extracted user feature and a user feature of an existing user included in the user data.

The estimating of the identifier of the current user may include determining a similarity between the current user and an existing user included in the user data based on the extracted user feature, and allocating an identifier of the existing user to the current user in response to the determined similarity satisfying a preset condition. The updating of the user data may include updating user data of the existing user based on the extracted user feature.

The estimating of the identifier of the current user may include determining a mid-level feature based on a plurality of user features extracted from input data for the current user, and estimating the identifier of the current user based on the mid-level feature. The determining of the mid-level feature may include combining the plurality of user features extracted for the current user and performing vectorization of images of the extracted user features to determine the mid-level feature. The determining of the mid-level feature may include performing vectorization on the plurality of user features extracted for the current user based on a codeword generated from learning data to determine the mid-level feature. The estimating of the identifier of the current user based on the mid-level feature may include determining a similarity between the current user and each existing user prestored in the user data based on the mid-level feature, and determining an identifier, as the estimated identifier, of the current user to be an identifier of an existing user in response to the similarity being greater than or equal to a preset threshold value and being greatest among similarities of existing users. The estimating of the identifier of the current user based on the mid-level feature may include determining a similarity between the current user and each existing user prestored in the user data based on the mid-level feature, and allocating to the current user an identifier different from identifiers of existing users in response to each determined similarity being less than a preset threshold value.

The estimating of the identifier of the current user may include determining a similarity between the current user and an existing user included in the user data, with respect to each user feature extracted for the current user, and estimating the identifier of the current user based on the determined similarity with respect to each extracted user feature. The estimating of the identifier of the current user based on the similarity determined with respect to each extracted user feature may include determining a first similarity with respect to each extracted user feature between the current user and each of existing users included in the user data, determining a second similarity between the current user and each of the existing users based on the first similarity determined with respect to each extracted user feature determining an identifier of the current user, as the estimated identifier, to be an identifier of an existing user having a second similarity being greater than or equal to a preset threshold value and being greatest among second similarities of the existing users, or allocating to the current user an identifier different from identifiers of the existing users in response to each of the second similarities of the existing users being less than the threshold value.

The extracting of the user feature may include respectively extracting any one or any combination of one or more of clothing, a hairstyle, a body shape, and a gait of the current user from image data, and/or extracting any one or any combination of one or more of a voiceprint and a footstep of the current user from audio data.

The input data may include at least one of image data and audio data, and the extracting of the user feature may include dividing at least one of the image data and the audio data for each user, and extracting the user feature of the current user from at least one of the divided image data and the divided audio data.

The extracting of the user feature of the current user may include extracting a user area of the current user from image data, and transforming the extracted user area into a different color model.

The extracting of the user feature of the current user may include extracting a patch area from a user area of the current user in image data, extracting color information and shape information from the extracted patch area, and determining a user feature associated with clothing of the current user based on the color information and the shape information.

The extracting of the user feature of the current user may include extracting a landmark associated with a body shape of the current user from image data, determining a body shape feature distribution of the current user based on information on the surroundings of the extracted landmark, and determining a user feature associated with the body shape of the current user based on the body shape feature distribution.

In another general aspect, a non-transitory computer-readable storage medium storing instructions that, when executed by a processor, may cause the processor to perform the above method.

In another general aspect, a user recognition method includes extracting a user area of a current user from image data, extracting a user feature of the current user from the user area, estimating an identifier of the current user based on the extracted user feature and prestored user data, and performing unsupervised learning or updating of user data of an existing user included in the user data based on a result of the estimating.

In response to a determined absence of an existing user corresponding to the current user, the estimating of the identifier of the current user may include allocating an identifier different from an identifier of the existing user to the current user. The performing of the unsupervised learning may include performing the unsupervised learning based on the extracted user feature and a user feature of the existing user.

In response to presence of an existing user corresponding to the current user, the estimating of the identifier of the current user may include determining an identifier of the existing user to be the identifier of the current user. The updating of the user data of the existing user may include updating user data of the existing user corresponding to the current user based on the extracted user feature.

In another general aspect, a user recognition device includes a processor configured to extract a user feature of a current user from input data, estimate an identifier of the current user based on the extracted user feature, and generate an identifier of the current user in response to a determined absence of an identifier corresponding to the current user and update user data based on the generated identifier and the extracted user feature.

The user recognition device may further include a memory configured to store instructions, wherein the processor may be further configured to execute the instructions to configure the processor to extract the user feature of the current user from the input data, estimate the identifier of the current user based on the extracted user feature, and generate the identifier of the current user in response to the determined absence of the identifier corresponding to the current user and update user data based on the generated identifier and the extracted user feature.

The processor may include a user feature extractor configured to extract the user feature of the current user from the input data, a user identifier estimator configured to estimate the identifier of the current user based on the extracted user feature, and a user data updater configured to generate the identifier of the current user in response to the determined absence of the identifier corresponding to the current user and update user data based on the generated identifier and the extracted user feature.

The user identifier estimator may include a similarity determiner configured to determine a similarity between the current user and an existing user included in the user data based on the extracted user feature.

The similarity determiner may include a mid-level feature determiner configured to determine a mid-level feature based on a plurality of user features extracted for the current user.

The user recognition device may be a smart phone, tablet, laptop, or vehicle that includes at least one of a microphone and camera to capture the input data. The processor may be further configured to control access or operation of the user recognition device based on a determined authorization process to access, operate, or interact with feature applications of the user recognition device, dependent on the determined similarity.

The user data updater may include an unsupervised learning performer configured to perform unsupervised learning based on the generated identifier and the extracted user feature.

The user feature extractor may include a preprocessor configured to extract a user area of the current user from image data, and transform the extracted user area into a different color model.

Other features and aspects will be apparent from the following detailed description, the drawings, and the claims.

### BRIEF DESCRIPTION OF DRAWINGS

FIG. 1 is a diagram illustrating an example of a user recognition device.

FIG. 2 is a flowchart illustrating an example of a user recognition method.

FIG. 3 is a diagram illustrating an example of a process of extracting a clothing feature of a user.

FIG. 4 is a diagram illustrating an example of a process of determining a mid-level feature.

FIG. 5 is a flowchart illustrating an example of a process of determining a user label based on a mid-level feature.

FIG. 6 is a diagram illustrating an example of a process of extracting a user feature.

FIG. 7 is a flowchart illustrating an example of a process of determining a user label based on each user feature.

FIG. 8 is a flowchart illustrating an example of a process of updating a classifier of a cluster based on an extracted user feature.

FIG. 9 is a flowchart illustrating an example of a process of performing unsupervised learning.

FIG. 10 is a flowchart illustrating an example of a user recognition method.

FIG. 11 is a flowchart illustrating an example of a user recognition method.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

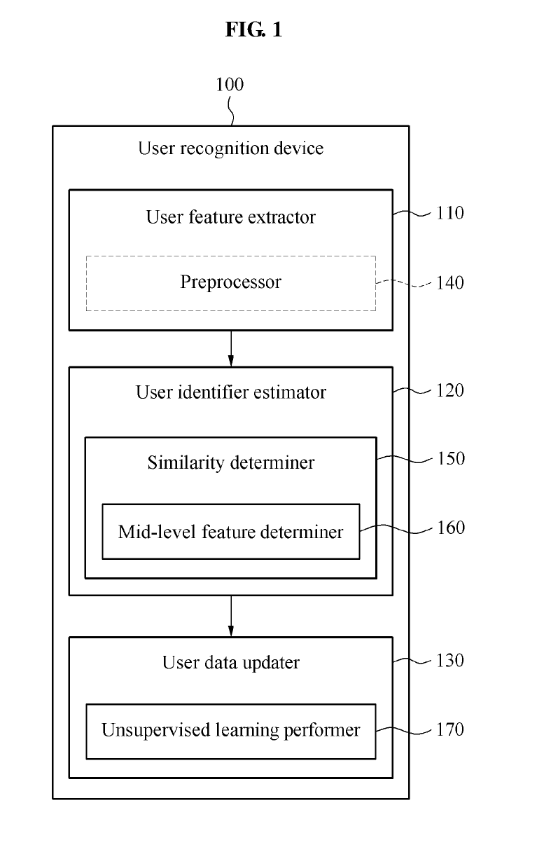

FIG. 1 is a diagram illustrating an example of a user recognition device 100.

Referring to FIG. 1, the user recognition device 100 may recognize a user by estimating the number of users based on input data, for example, image data and audio data, and distinguishing the users from one another. The user recognition device 100 may determine a user based on various visual and auditory features of the user without using face information of the user. The user recognition device 100 may effectively recognize a user using various features of the user, despite a change in clothing, a body shape, and/or a movement path of the user, or a change in a surrounding environment around the user, for example, illumination or background environment.

When a new user is recognized or a new type or category of information about the user is provided or becomes available, e.g., through a newly added, enabled, or permitted-shared access camera, microphone, or locator (GPS) device of the user recognition device 100, the user recognition device 100 may set a category or a cluster for the new user or new type or category of information through unsupervised learning, and update prestored user data. The prestored user data may further include user preferences, and the user recognition device 100 may control a device to authorize or deny access to a user based on a recognition result of the user. Additionally the user recognition device 100 may control a device to configure the user interface according to the user preferences, such as setting a brightness level of the user interface, general appearance of the user interface, or adjusting a position of a seat of a device, as examples only. When a current user who is a target to be recognized is determined to correspond to an existing user, the user recognition device 100 may update data of the existing user based on information extracted from the current user. Thus, the user recognition device 100 may recognize a user and continuously update corresponding the user data without additional pre-learned information about the user. The user data may be prestored in memory of the user recognition device 100 or in an external memory connected to the user recognition device 100.

Referring to FIG. 1, the user recognition device 100 includes a user feature extractor 110, a user identifier estimator 120, and a user data updater 130. The user feature extractor may be representative of, or include a camera and/or microphone. The camera and/or microphone may be external to the user feature extractor 110 and/or the user recognition device 100, and there may also be multiple cameras or microphones available in a corresponding user recognition system for use in the recognition process.

The user feature extractor 110 may extract a user feature from input data, such as, for example, image data and audio data. In an example, the user feature extractor 110 may divide, categorize, or separate the image data or the audio data for each user, and extract a user feature of a current user from the divided, categorized, or separated image data or the divided, categorized, or separated audio data. For example, when a plurality of users is included in the image data, the user feature extractor 110 may divide, categorize, or separate a user area for each user, and extract a user feature from each divided, categorized, or separated user area. In further example, the user feature extractor 110 may remove noise included in the image data or the audio data from the image data or the audio data before extracting the user feature from the image data or the audio data.

The user feature extractor 110 may extract the user feature or characteristic of the current user, for example, a face, clothing, a hairstyle, a body shape, a gesture, a pose, and/or a gait of the current user, from the image data.

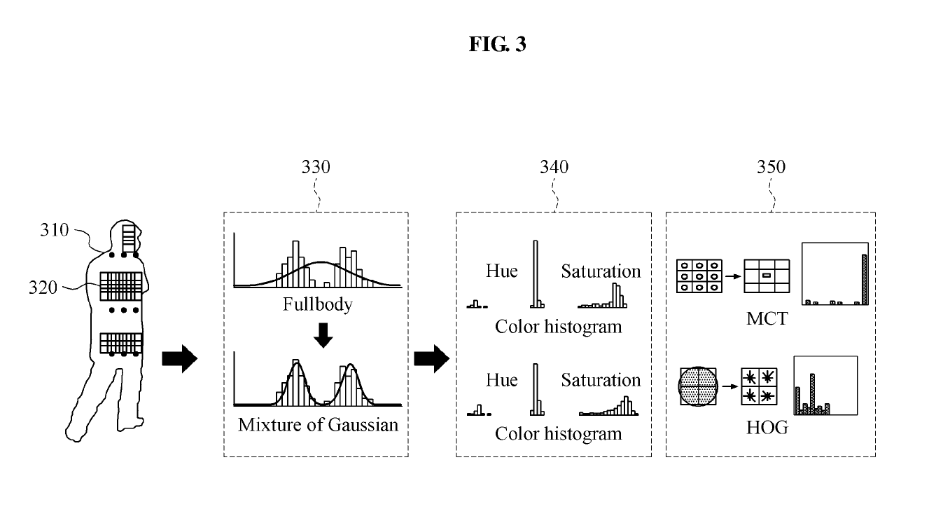

In an example, the user feature extractor 110 may extract a patch area of the current user from the image data to extract a user feature associated with the clothing of the current user. The patch area refers to a small area configured as, for example, 12(x)×12(y). The user feature extractor 110 may extract color information and shape information from the extracted patch area, and determine the user feature associated with the clothing of the current user based on the extracted color information and the extracted shape information. A description of extracting a user feature associated with clothing will be provided with reference to FIG. 3.

The user feature extractor 110 may extract an attribute, or characteristic, of a hair area of the current user from the image data to extract a user feature associated with the hairstyle of the current user. The attribute or characteristic of the hair area may include, for example, a hair color, a hair volume, a hair length, a hair texture, a surface area covered by hair, a hairline, and hair symmetry.

The user feature extractor 110 may extract a landmark, as a feature point of the body shape of the current user, from the image data and determine a body shape feature distribution of the current user based on information on the surroundings of the extracted landmark in order to extract a user feature associated with the body shape of the current user. For example, the user feature extractor 110 may extract the landmark from the image data using a feature point extracting method, such as, for example, a random detection, a scale-invariant feature transform (SIFT), and a speeded up robust feature (SURF) method, or using a dense sampling method, as understood by one skilled in the art after an understanding of the present application. The user feature extractor 110 may determine the user feature associated with the body shape of the current user based on the body shape feature distribution.

Also, the user feature extractor 110 may use an image, such as, for example, a gait energy image (GEI), an enhanced GEI, an active energy image, and a gait flow image, as understood by one skilled in the art after an understanding of the present application, and use information about a change in a height and a gait width of the current user based on time in order to extract a user feature associated with the gait of the current user. Although the user feature extractor 110 may determine the user feature associated with the gait, for example, a width signal and a height signal of the gait, by combining the image such as the GEI, the change in the height based on time, and the change in the gait width based on time, embodiments are not limited to a specific method, and one or more methods may be combined to extract a user gait feature.

The user feature extractor 110 may extract, from the audio data, a user feature associated with, for example, a voiceprint and/or a footstep of the current user. The voiceprint is a unique feature different from individual users, and does not change despite a lapse of time. The footstep is also a unique feature different from individual users depending on a habit, a body shape, a weight, and a preferred type of shoes of a user.

In another example, the user feature extractor 110 may additionally include a preprocessor 140 configured to perform preprocessing on the image data before the user feature is extracted. The preprocessor 140 may extract a user area of the current user from the image data, and transform the extracted user area into a different color model. For example, the preprocessor 140 may transform the user area of the current user into the different color model, for example, a hue-saturation-value (HSV) color model. The preprocessor 140 may use a hue channel and a saturation channel of the HSV color model that are robust against a change in illumination, and may not use a value channel. However, embodiments are not limited to the use of a specific channel. The user feature extractor 110 may extract the user feature of the current user from the image data obtained through the preprocessing. The user feature of the current user may be extracted from the image data obtained by performing the preprocessing described above.

The user identifier estimator 120 may estimate an identifier, for example, a user label, of the current user based on the user feature extracted for the current user. The user identifier estimator 120 may determine whether the current user corresponds to an existing user included in the user data based on the extracted user feature, and estimate the identifier of the current user based on a result of the determining. For example, the user identifier estimator 120 may determine presence or absence of an identifier corresponding to the current user based on the user data. In response to the absence of the identifier corresponding to the current user, the user identifier estimator 120 may generate a new identifier of the current user. The user data updater 130 may perform unsupervised learning or update user data of an existing user included in the user data based on a result of the estimating, as discussed in greater detail below. The user data updater 130 may include an unsupervised learning performer 170 configured to perform the unsupervised learning using one or more processors of the user data updater 130 or the user recognition device 100, for example. When the new identifier of the current user is generated, the user data updater 130 may update the user data based on the generated identifier and the user feature extracted for the current user.

The user identifier estimator 120 may include a similarity determiner 150. The similarity determiner 150 may determine a similarity between the current user and an existing user included in the user data based on the user feature extracted for the current user. The similarity between the current user and the existing user indicates a likelihood of the current user matching the existing user. A high similarity of the existing user indicates a high likelihood of the current user matching the existing user. Conversely, a low similarity of the existing user indicates a low likelihood of the current user matching the existing user.

The user data may include distinguishable pieces of feature data of different users. For example, the user data may include user feature data of a user A, user feature data of a user B, and user feature data of a user C. In the user data, the user A, the user B, and the user C may form different clusters, and each different cluster may include feature data associated with a corresponding user. A cluster of a new user may be added to the user data, and boundaries among the clusters may change through learning. Herein, clustering may include respective groupings of objects or information about or with respect to a user so such objects or information are more similar to each other than those in other clusters, e.g., as a data mining or statistical data analysis implemented through unsupervised machine learning, neural networks, or other computing technology implementations. Varying types of clusters may be used depending on the underlying information and combinations of different types of information, including centroid model clustering, connectivity based or model clustering, density model clustering, distribution model clustering, subspace model clustering, group model clustering, graph-based model clustering, strict portioning clustering, overlapping clustering, etc., or any combination of the same, as would be understood by one of ordinary skill in the art after a full understanding of the present disclosure. A clustering for a particular user may further include clusters of clusters for the user.

When the similarity between the current user and the existing user satisfies a preset condition, the user identifier estimator 120 may allocate an identifier, e.g., a user characteristic, of the existing user to the current user. For example, the user identifier estimator 120 may determine the current user to be an existing user when the identifier of the current user and an identifier of an existing user have a calculated similarity that meets or is greater than a preset threshold value and is greatest among the existing users. The user data updater 130 may then update user data of the existing user based on the user feature extracted for the current user.

Conversely, when the calculated similarity between the current user and the existing user does not satisfy the preset condition, the user identifier estimator 120 may allocate to the current user a new identifier different from the identifier of an existing user. For example, when respective similarities with respect to the existing users are each less than the preset threshold value, the user identifier estimator 120 may allocate to the current user a new identifier different from the respective identifiers of the existing users. The unsupervised learning performer 170 may then perform the unsupervised learning based on the new identifier allocated to the current user, the user feature extracted for the current user, and a user feature of an existing user included in the user data, such as discussed above with respect to the example clustering unsupervised learning or through other algorithmic or machine learning modeling, or neural networking, computer technology approaches, as would be understood by one skilled in the art after a full understanding of the present application. For example, the unsupervised learning performer 170 may perform the unsupervised learning on the user data using, for example, a K-means or centroid clustering algorithm, such as discussed above, and/or a self-organizing map (SOM). Herein, the self-organizing map (SOM), or self-organizing feature map (SOFM), is an artificial neural network (ANN) that is trained using unsupervised learning to produce a low-dimensional, e.g., two-dimensional, discretized representation of the input space of the training samples, also called a map herein.

In response to presence of an existing user corresponding to the current user, the user identifier estimator 120 may determine an identifier of the existing user to match the identifier of the current user. For example, the similarity determiner 150 may calculate a similarity between the user feature extracted for the current user and a user feature of each existing user included in the user data, and the user identifier estimator 120 may determine whether the user feature extracted for the current user is a new feature based on the calculated similarity. When the user feature extracted for the current user is not determined to be the new feature, but to be, or match, a user feature of an existing user, the user identifier estimator 120 may determine an identifier of the existing user to be the identifier of the current user. The user data updater 130 may then update user data of the existing user corresponding to the current user based on the user feature extracted for the current user. For example, when the current user is determined to correspond to an existing user A, the user data updater 130 may recognize the current user as the existing user A, and update feature data of the existing user A based on the user feature extracted for the current user.

In response to absence of an existing user corresponding to the current user, the user identifier estimator 120 may allocate to the current user an identifier different from an identifier of an existing user. The unsupervised learning performer 170 may perform the unsupervised learning based on the user feature extracted for the current user and/or a user feature of an existing user. For example, when the current user is determined not to correspond to any existing user included in the user data, the user identifier estimator 120 may allocate, to the current user, a new identifier different from the respective identifiers of the existing users. The unsupervised learning performer 170 may then add a cluster corresponding to the new identifier to the user data, and perform the unsupervised learning based on the user feature extracted for the current user and the user features of the existing users.

Hereinafter, a description of estimating an identifier of the current user is provided.

In an example, the similarity determiner 150 may determine a first similarity with respect to each user feature extracted for the current user between the current user and each of the existing users included in the user data, and determine a second similarity between the current user and each of the existing users based on the first similarity determined with respect to each user feature. The user identifier estimator 120 may determine the current user to be an existing user when the identifier of the current user and an identifier of an existing user have a second similarity that meets or is greater than a preset threshold value and is greatest among second similarities of the existing users. When an identifier of the existing user is allocated to the current user, the user data updater 130 may update feature data of the existing user based on the user feature extracted for the current user. When the second similarities of the existing users are less than the preset threshold value, the user identifier estimator 120 may allocate to the current user a new identifier different from the identifiers of the existing users. When the new identifier is allocated to the current user, the unsupervised learning performer 170 may perform the unsupervised learning based on the user feature extracted for the current user.

For example, when the user features associated with the hairstyle and the body shape of the current user are extracted from the image data, and a user A and a user B are present as the existing users, the similarity determiner 150 may determine a first similarity in hairstyle between the current user and the user A and a first similarity in body shape between the current user and the user A, and a first similarity in hairstyle between the current user and the user B and a first similarity in body shape between the current user and the user B. The similarity determiner 150 may then determine a second similarity between the current user and the user A based on the first similarity in hairstyle between the current user and the user A and the first similarity in body shape between the current user and the user A, and also determine a second similarity between the current user and the user B based on the first similarity in hairstyle between the current user and the user B and the first similarity in body shape between the current user and the user B. When the second similarity between the current user and the user A is greater than the second similarity between the current user and the user B, and is greater than the preset threshold value, the user identifier estimator 120 may recognize the current user as user A. The user data updater 130 may update a classifier for user A based on the user features extracted for the current user in association with the hairstyle and the body shape of the current user. When the second similarity between the current user and the user A and the second similarity between the current user and the user B are both less than or equal to the preset threshold value, the user identifier estimator 120 may allocate a new identifier C to the current user and recognize the current user as a new user C.

The unsupervised learning performer 170 may then perform the unsupervised learning on the user features extracted for the current user in association with the hairstyle and the body shape and on prestored feature data of the users A and B, based on clusters of the users A and B, and the new user C. As a result of the unsupervised learning, a boundary between clusters corresponding to pieces of feature data of the users A and B may change.

In an example, the similarity determiner 150 may include a mid-level feature determiner 160. The mid-level feature determiner 160 may generate a mid-level feature based on a plurality of user features extracted from the current user, and the user identifier estimator 120 may estimate the identifier of the current user based on the mid-level feature. Here, the mid-level feature may be a combination of two or more user features. For example, the mid-level feature determiner 160 may vectorize the user features extracted for the current user by combining the user features extracted for the current user, or vectorize the user features extracted for the current user based on a codeword generated from learning data. The similarity determiner 150 may determine a similarity between the current user and an existing user based on the mid-level feature, for example. The user identifier estimator 120 may determine the current user to be an existing user when the identifier of the current user and an identifier of an existing user have a similarity being greatest among the existing users and that meets or is greater than the preset threshold value. When the identifier of the existing user is allocated to the current user, the user data updater 130 may update feature data of the existing user based on the user feature extracted for the current user. When the similarities of the existing users are less than the preset threshold value, the user identifier estimator 120 may allocate to the current user a new identifier different from the identifiers of the existing users. When the new identifier is allocated to the current user, the unsupervised learning performer 170 may perform the unsupervised learning based on the user feature extracted for the current user.

For example, when the user features associated with the hairstyle and the body shape of the current user are extracted from image data, and a user A and a user B are present as the existing users, the mid-level feature determiner 160 may simply combine and vectorize the extracted user features associated with the hairstyle and the body shape of the current user, or transform the user features associated with the hairstyle and the body shape of the current user into a mid-level feature through a bag-of-words (BoW) method as understood by one skilled in the art after an understanding of the present application. The similarity determiner 150 may determine a similarity between the current user and user A and a similarity between the current user and user B based on the mid-level feature. When the similarity between the current user and user A is greater than the similarity between the current user and user B, and meets or is greater than the preset threshold value, the user identifier estimator 120 may recognize the current user as user A. The user data updater 130 may update a classifier for user A based on the extracted user features associated with the hairstyle and the body shape of the current user, for example. When the similarity between the current user and user A and the similarity between the current user and user B are both less than the preset threshold value, the user identifier estimator 120 may allocate a new identifier C, for example, to the current user, and recognize the current user as a new user C. The unsupervised learning performer 170 may perform unsupervised learning on the extracted user features associated with, for example, the hairstyle and the body shape of the current user and on prestored pieces of feature data of users A and B, based on clusters of users A and B, and new user C.

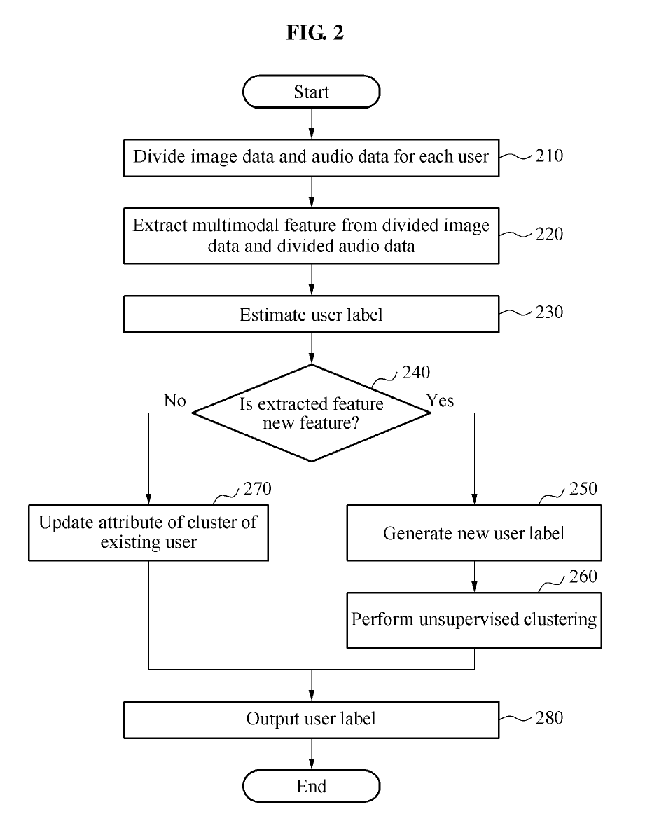

FIG. 2 is a flowchart illustrating an example of a user recognition method.

In operation 210, a user recognition device divides, categorizes, or separates input data, for example, image data and audio data, for each user. The user recognition device may extract a user area of a current user from the image data and the audio data divided, categorized, or separated for each user, and transform a color model of the extracted user area. In a further example, the user recognition device may remove noise from the image data and the audio data. Here, as only an example, the user recognition device may correspond to the user recognition device 100 of FIG. 1, noting that embodiments are not limited to the same.

In operation 220, the user recognition device extracts a multimodal feature of the current user from the input data divided, categorized, or separated for each user. For example, the user recognition device may extract a feature associated with, for example, a hairstyle, clothing, a body shape, a voiceprint, and a gait of the current user, from the input data divided, categorized, or separated for each user.

In operation 230, the user recognition device estimates a user label based on the extracted multimodal feature.

In operation 240, the user recognition device determines whether a feature of the current user extracted from the image data or the audio data is a new feature that is not previously identified. For example, the user recognition device may determine a similarity between the current user and each of existing users included in user data based on the extracted feature of the current user and pieces of feature data of the existing users included in the user data, and determine whether the extracted feature is the new feature that is not previously identified based on the determined similarity.

In operation 250, in response to a low similarity between the feature extracted for the current user and a feature extracted from an existing user included in the user data, e.g., the similarity does not meet the preset threshold, the user recognition device may recognize the current user as a new user, and generate a new user label for the current user. When the new user label is generated, a cluster corresponding to the new user label may be added to the user data.

In operation 260, the user recognition device performs unsupervised clustering, such as, for example, K-means clustering, based on the feature extracted for the current user and the feature data of the existing users included in the user data.

The user data may be generated through a separate user registration process performed at an initial phase, or generated through the unsupervised clustering without the separate user registration process. For example, no user may be initially registered in the user data, and the operation of generating a new user label and the operation of performing the unsupervised clustering may be performed once a feature extracted from a user is determined to be a new feature. Thus, without the separate user registration process, pieces of feature data of users may be accumulated in the user data.

In operation 270, in response to a high similarity between the feature extracted for the current user and a feature extracted from an existing user included in the user data, e.g., the similarity meets or is greater than the preset threshold value and greatest among existing users, the user recognition device allocates a user label of the existing user to the current user, and updates an attribute of a cluster of the existing user based on the feature extracted for the current user.

In operation 280, the user recognition device outputs, as a user label of the current user, the new user label generated in operation 250 or the user label of the existing user allocated to the current user in operation 270.

FIG. 3 is a diagram illustrating an example of a process of extracting a clothing feature of a user.

A user recognition device may sample or extract a patch area 320 from a user area 310 of a current user. For example, sampling the patch area 320 may be performed using a method of extracting a patch area at a random location, a method of extracting a main location and extracting a patch area at the extracted main location using, for example, an SIFT and/or an SURF, or a dense sampling method. The dense sampling method may extract a large number of patch areas at preset intervals without a predetermined condition, and may extract sufficient information from a user area. Here, as only an example, the user recognition device may correspond to the user recognition device 100 of FIG. 1, e.g., with operations of FIG. 3 corresponding to operations of the user feature extractor 110 of FIG. 1, noting that embodiments are not limited to the same.

Since information of an extracted patch area include various factors being mixed therewith, the user recognition device may separate the factors included in the patch area from one another using a mixture of Gaussians (MoG) or a mixture of factor analyzers (MoFA), as understood by one skilled in the art after an understanding of the present application. FIG. 3 illustrates an example of using an MoG 330. The MoG 330 may be represented by the below Equation 1, for example.

$$Pr ( x \vert θ ) = {\sum }_{k = 1}^{K} {λ}_{k} {Norm}_{x} [ {μ}_{k} , {Σ}_{k} ] \qquad Equation 1$$

In Equation 1, “K” denotes the number of mixed Gaussian distributions, “λₖ” denotes a weighted value of a k-th Gaussian distribution, “μₖ” denotes a mean of the k-th Gaussian distribution, “Σₖ” denotes a standard deviation of the k-th Gaussian distribution, and “Normₓ” denotes a normal Gaussian distribution expressed by the mean and the standard deviation. “Pr(x|θ)” denotes a likelihood of data x when a parameter θ indicating a mixture of Gaussian distributions is given. The likelihood of the data x may be expressed as an MoG indicated by the given θ(K, λₖ, μₖ, Σₖ).

The user recognition device may extract color information 340, for example, a color histogram, and shape information 350, for example, modified census transform (MCT) and a histogram of oriented gradients (HoG). The user recognition device may determine a clothing feature of the current user based on the color information 340 and the shape information 350 extracted from the patch area 320.

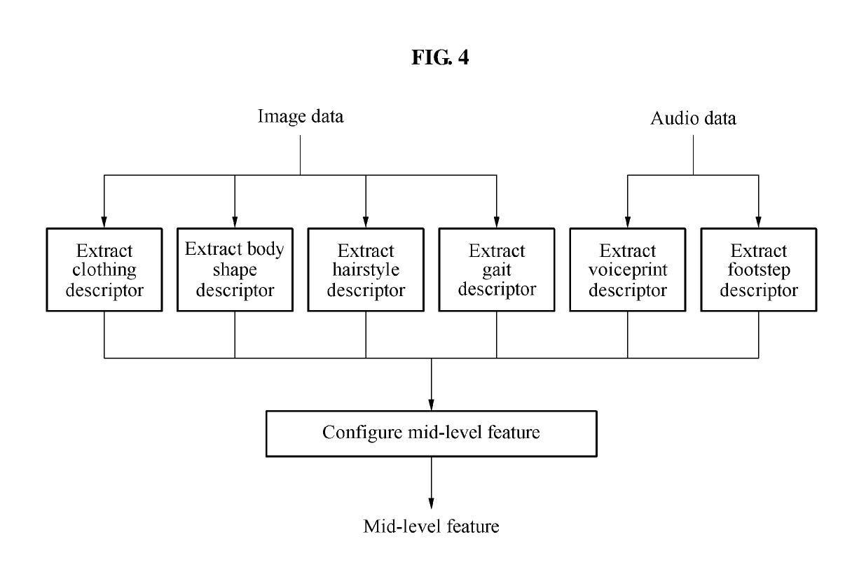

FIG. 4 is a diagram illustrating an example of a process of determining a mid-level feature.

A user recognition device may extract a user feature, for example, a clothing descriptor, a body shape descriptor, a hairstyle descriptor, and a gait descriptor, from image data. In addition, the user recognition device may extract a user feature, for example, a voiceprint descriptor and a footstep descriptor, from audio data. The user recognition device may form a mid-level feature based on the extracted clothing descriptor, the extracted body shape descriptor, the extracted hairstyle descriptor, the extracted gait descriptor, the extracted voiceprint descriptor, and the extracted footstep descriptor. Here, the user recognition device may correspond to the user recognition device 100 of FIG. 1, e.g., with operations of FIG. 4 corresponding to operations of the user feature extractor 110 of FIG. 1, though embodiments are not limited to the same. The mid-level feature may be formed through various methods.

For example, the user recognition device may form the mid-level feature through vectorization and simply combining the extracted user features. For another example, the user recognition device may form a BoW from a code word generated by clustering, in advance, feature data indicated in various sets of learning data. The BoW may be formed by expressing a feature extracted from the image data as a visual word through vector quantization, and indicating the visual word as a value. Alternatively, the user recognition device may form, as a mid-level feature, a multimodal feature extracted from a current user through other various methods, however, embodiments are not limited thereto.

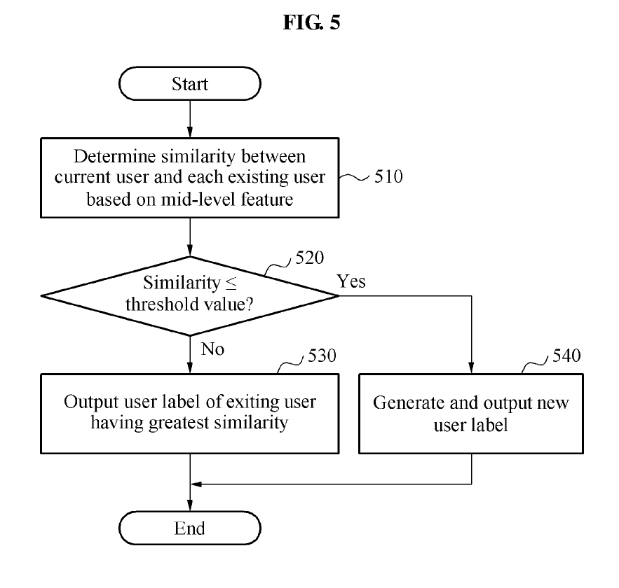

FIG. 5 is a flowchart illustrating an example of a process of determining a user label based on a mid-level feature.

In operation 510, a user recognition device determines a similarity between a current user and each of existing users included in user data based on a mid-level feature. Here, as only an example, the user recognition device may correspond to the user recognition device 100 of FIG. 1, e.g., with operations of FIG. 5 corresponding to operations of the user identifier 120 of FIG. 1, noting that embodiments are not limited to the same. The user recognition device may use the mid-level feature as an input, and calculate a likelihood of the current user matching an existing user using a classifier for the existing users. The user recognition device may calculate a likelihood that the mid-level feature belongs to each cluster using a classifier of a cluster corresponding to each existing user.

For example, when the number of the existing users registered in the user data is two, and each existing user has a user label A and a user label B and has a probabilistic density function (PDF) Pr(x) associated with each user feature, a likelihood associated with a mid-level feature x may be defined as a similarity. For example, a multivariate Gaussian distribution PDF may be used as the PDF and, by applying the PDF to a naive Bayes classifier, the example Equation 2 below may be obtained.

$$P ( c \vert x ) = \frac{P ( x \vert c ) P ( c )}{P ( x )} \qquad Equation 2$$

In Equation 2, “P(c|x)” denotes a likelihood that a user label of a current user is a user level c, when a mid-level feature x is given. Here, P(c|x) indicates a likelihood of the mid-level feature x from a PDF associated with the user label c. “P(c)” denotes a prior probability. Alternatively, other methods, for example, a restricted Boltzman machine (RBM) based deep belief network (DBN), a deep Boltzman machine (DBM), a convolutional neural network (CNN), and a random forest, may be used, in addition or alternatively to the above discussed algorithmic unsupervised learning approaches.

In operation 520, the user recognition device determines whether the similarity between the current user and each existing user is less than or equal to a preset threshold value.

In operation 530, the user recognition device outputs, as a user label of the current user, a user label of an existing user having a similarity being greater than the preset threshold value and being greatest among similarities of the existing users.

In operation 540, when all of the similarities of the existing users is less than or equal to the preset threshold value, the user recognition device recognizes the current user as a new user and generates a new user label of the current user, and outputs the newly generated user label as the user label of the current user.

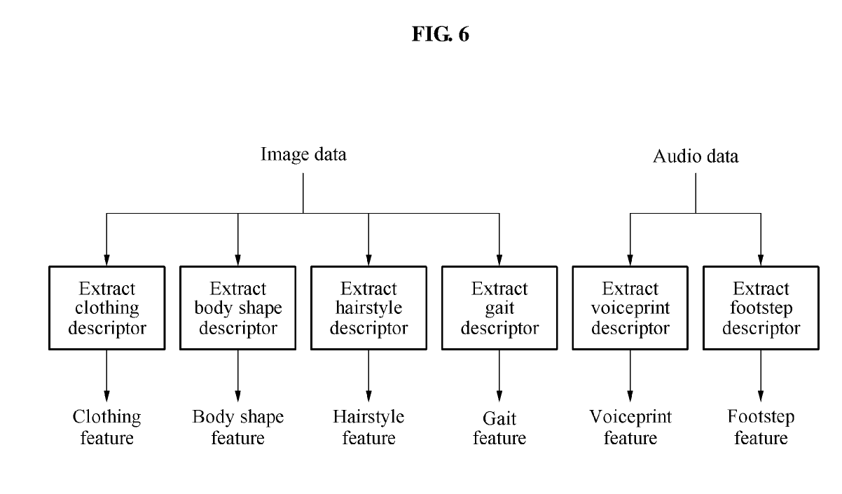

FIG. 6 is a diagram illustrating an example of a process of extracting a user feature.

A user recognition device may extract a user feature, for example, a clothing descriptor, a body shape descriptor, a hairstyle descriptor, and a gait descriptor, from image data. In addition, the user recognition device may extract a user feature, for example, a voiceprint descriptor and a footstep descriptor, from audio data. Here, the user recognition device may correspond to the user recognition device 100 of FIG. 1, e.g., with operations of FIG. 6 corresponding to operations of the user feature extractor 110 of FIG. 1, though embodiments are not limited to the same. The user recognition device may perform a user recognition process using such user features, independently, without forming a mid-level feature from the user features, for example, the clothing descriptor, the body shape descriptor, the hairstyle descriptor, the gait descriptor, the voiceprint descriptor, and the footstep descriptor.

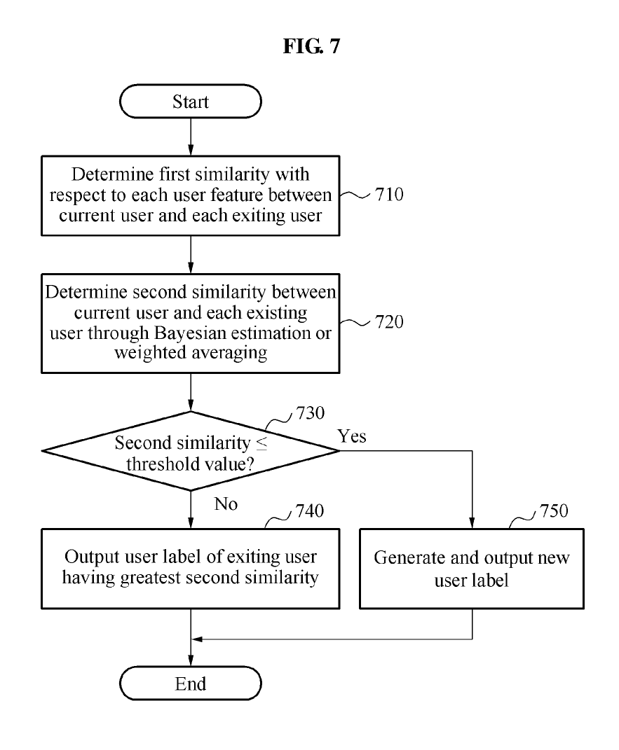

FIG. 7 is a flowchart illustrating an example of a process of determining a user label based on each user feature.

In operation 710, a user recognition device determines a first similarity with respect to each user feature between a current user and each of existing users included in user data. Here, the user recognition device may correspond to the user recognition device 100 of FIG. 1, e.g., with operations of FIG. 7 corresponding to operations of the similarity determiner 150 and/or the user identifier estimator 120 of FIG. 1, though embodiments are not limited to the same. The user recognition device may determine the first similarity between the current user and an existing user using individual feature classifiers of the existing users included in the user data. For example, when the number of the existing users in the user data is K and the number of user features extracted for the current user is F, the number of the feature classifiers of the existing users may be K×F.

In operation 720, the user recognition device determines a second similarity between the current user and each of the existing users through Bayesian estimation or weighted averaging. The user recognition device may determine the second similarity between the current user and an existing user based on the first similarity of the existing user determined by an individual feature classifier of the existing user. For example, the user recognition device may determine the second similarity through the Bayesian estimation represented by the example Equation 3 below.

$$P ( c \vert x ) = {\prod }_{i = 1}^{F} {P}_{i} ( c \vert x ) \qquad Equation 3$$

In Equation 3, “Pᵢ(c|x)” denotes a probability (or likelihood) that a user label of a current user based on a user feature i is c when F user features are extracted. “P(c|x)” denotes a probability (or likelihood) that a user label of the current user based on all the extracted user features is c.

For another example, the user recognition device may determine the second similarity through the weighted averaging represented by the example Equation 4 below.

$$P ( c \vert x ) = {\sum }_{i = 1}^{F} log ( {P}_{i} ( c \vert x ) ) \qquad Equation 4$$

In Equation 4, “Pᵢ(c|x)” denotes a probability (or likelihood) that a user label of a current user based on a user feature i is c when F user features are extracted. “P(c|x)” denotes a probability (or likelihood) that a user label of the current user based on all the extracted user features is c.

In operation 730, the user recognition device determines whether a second similarity between the current user and each of the existing users is less than or equal to a preset threshold value.

In operation 740, the user recognition device outputs, as a user label of the current user, a user label of an existing user having a second similarity being greater than the preset threshold value and being greatest among second similarities of the existing users.

In operation 750, when the second similarities of the existing users are all less than or equal to the preset threshold value, the user recognition device recognizes the current user as a new user and generates a new user label of the current user, and outputs the generated user label as the user label of the current user.

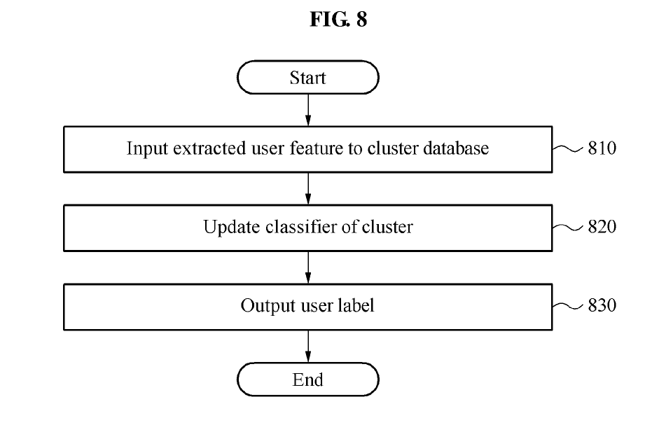

FIG. 8 is a flowchart illustrating an example of a process of updating a classifier of a cluster based on an extracted user feature.

One or more embodiments include controlling one or more processors to update user information through clusters of existing users included in user data being incrementally learned. When a current user is recognized as an existing user among the existing users in the user data, e.g., by a user recognition device, an example same user recognition device may control a cluster of the existing user included in the user data to be updated based on a user feature extracted for the current user. Here, the user recognition device may correspond to the user recognition device 100 of FIG. 1, e.g., with operations of FIG. 8 corresponding to operations of the user data updater 130.1, though embodiments are not limited to the same. In the example of FIG. 8, the current user is recognized as an existing user A.

In operation 810, the user recognition device inputs the user feature extracted for the current user to a cluster database of the existing user A.

In operation 820, the user recognition device controls an update of a classifier of the cluster corresponding to the existing user A based on the user feature extracted for the existing user A. When the classifier of the cluster is updated, a decision boundary of a cluster of each existing user included in the user data may change over time.

In operation 830, the user recognition device outputs a user label of the existing user A as the user label of the current user.

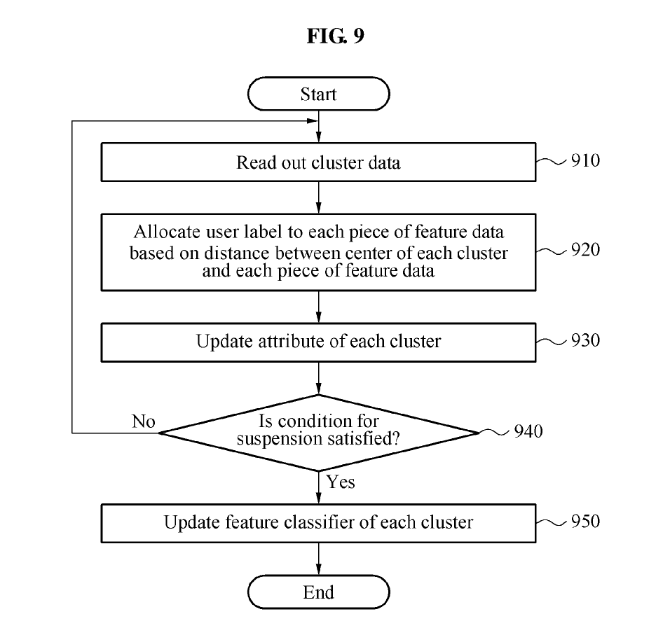

FIG. 9 is a flowchart illustrating an example of a process of performing unsupervised learning.

When a user recognition device recognizes a current user as a new user that is not an existing user included in user data, the example same user recognition device may generate a new user identifier of the current user and add a cluster corresponding to the generated user identifier to the user data. Here, the user recognition device may correspond to the user recognition device 100 of FIG. 1, e.g., with operations of FIG. 9 corresponding to operations of the user data updater 130 and/or unsupervised learning performer 170 of FIG. 1, though embodiments are not limited to the same. Based on the added cluster, user features of existing users included in the user data and a user feature extracted for the current user may be clustered again. For example, K-means clustering and SOM may be used as unsupervised clustering, and the K-means clustering will be described with reference to FIG. 9.

In operation 910, the user recognition device reads out cluster data included in the user data. Here, the user data is assumed to include three clusters corresponding to user labels A, B, and C, respectively, including the cluster of the new user.

In operation 920, the user recognition device allocates a user label to each piece of feature data based on a distance between a center of each cluster of each existing user and each piece of feature data. For example, the user recognition device may calculate a distance between respective centers of the clusters corresponding to the user labels A, B, and C and each piece of feature data, and allocate a user label corresponding to a cluster having a shortest distance to a corresponding piece of feature data.

For example, the user recognition device may allocate a user label to each piece of feature data based on the example Equations 5 and 6 below.

$$\begin{matrix}{m}_{k} = \frac{{\sum }_{i : C ( i ) = k} {x}_{i}}{{N}_{k}} , \\ k = 1 , … , K . & Equation 5 \\ C ( i ) = {arg min}_{1 \leq k \leq K} {‖ {x}_{i} - {m}_{k} ‖}^{2} , \\ i = 1 , … , N & Equation 6\end{matrix}$$

In Equations 5 and 6, “K” and “N” denote the number of clusters and the number of pieces of feature data, respectively. “mₖ” denotes a center of a k-th cluster, and indicates a cluster mean. As represented in Equation 6, a user label C(i) to be allocated to feature data i may be determined based on a distance between the center of the k-th cluster mₖ and the feature data i.

In operation 930, the user recognition device updates an attribute of each cluster. The user recognition device may map the N pieces of feature data to the clusters until a standard is satisfied.

In operation 940, the user recognition device determines whether a condition for suspension of unsupervised learning. For example, the user recognition device may determine that the condition for suspension is satisfied when a boundary among the clusters no longer change, when a preset number of repetitions is reached, or when a sum of distances between the pieces of feature data and a center of a cluster that is closest to each piece of feature data is less than a preset threshold value.

In operation 950, when the condition for suspension of unsupervised learning is satisfied, the user recognition device updates a feature classifier of each cluster. The user recognition device may update the classifiers corresponding to the user features included in each cluster.

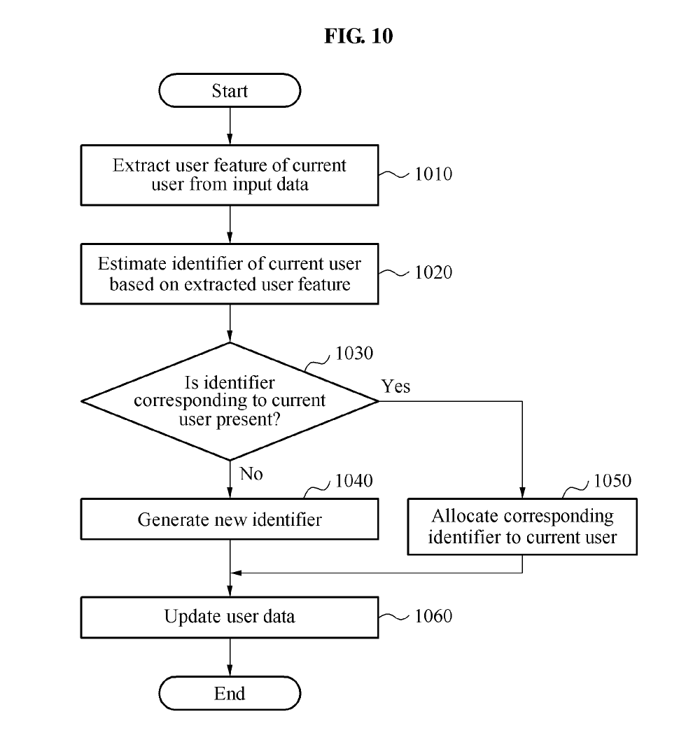

FIG. 10 is a flowchart illustrating an example of a user recognition method.

In operation 1010, a user recognition device extracts a user feature of a current user from input data. Here, the user recognition device may correspond to the user recognition device 100 of FIG. 1, e.g., with operations of FIG. 10 corresponding to operations of the user feature extractor 110, user identifier estimator 120, and user data updater 130 of FIG. 1, though embodiments are not limited to the same. The input data may include, for example, image data and audio data including a single user or a plurality of users captured by the user recognition device or remotely captured and provided to the user recognition device. When the image data includes a plurality of users, the user recognition device may divide, categorize, or separate a user area for each user and extract a user feature from each user area obtained through the division, categorization, or separation. For example, the user recognition device may extract a user feature of the current user, for example, a face, clothing, a hairstyle, a body shape, and a gait of the current user, from the image data, and extract a user feature of the current user, for example, a voiceprint and a footstep of the current user, from the audio data.

In operation 1020, the user recognition device estimates an identifier of the current user based on the user feature extracted for the current user. The user recognition device may determine a similarity between the current user and an existing user included in user data based on the user feature extracted for the current user, and estimate an identifier of the current user based on the determined similarity.

In operation 1030, the user recognition device determines whether an identifier corresponding to the current user is present. The user recognition device may determine whether the identifier corresponding to the current user is present among identifiers of existing users included in the user data. The user recognition device may determine whether the identifier corresponding to the current user is present by calculating a similarity between the user feature extracted for the current user and a user feature of each of the existing users included in the user data.

In operation 1040, in response to an absence of the identifier corresponding to the current user, the user recognition device generates a new identifier of the current user. For example, when a similarity between the current user and an existing user does not satisfy a preset condition, the user recognition device may allocate to the current user an identifier different from an identifier of the existing user. For example, when the similarities of the existing users are all less than or equal to a preset threshold value, the user recognition device may allocate to the current user a new identifier different from identifiers of the existing users. In operation 1060, the user recognition device updates the user data. For example, the user recognition device may perform unsupervised learning based on the new identifier allocated to the current user, the user feature extracted for the current user, and a user feature of an existing user. In detail, the user recognition device may add a cluster associated with the new identifier to the user data, and perform the unsupervised learning based on the user feature extracted for the current user and user features of the existing users.

In operation 1050, in response to presence of the identifier corresponding to the current user, the user recognition device allocates the identifier to the current user. When a similarity between the current user and an existing user satisfies the preset condition, the user recognition device may allocate an identifier of the existing user to the current user. For example, the user recognition device may determine, to be the identifier of the current user, an identifier of an existing user having a similarity being greater than a preset threshold value and being greatest among the similarities of the existing users. Alternatively, the user recognition device may calculate a similarity between the user feature extracted for the current user and a user feature of each existing user, and determine whether the user feature extracted for the current user is a new feature based on the calculated similarity. When the user feature extracted for the current user is determined not to be the new feature, but to be a user feature of an existing user, the user recognition device may determine an identifier of the existing user to be the identifier of the current user. In operation 1060, the user recognition device updates user data of the existing user corresponding to the current user based on the user feature extracted for the current user.

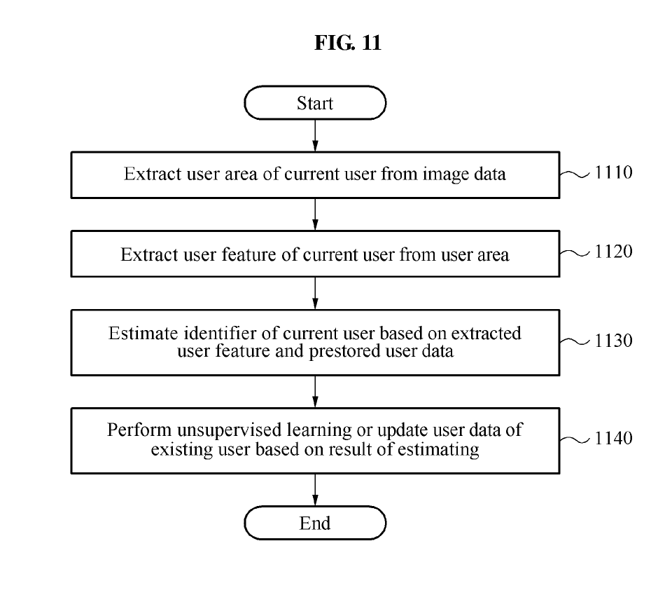

FIG. 11 is a flowchart illustrating an example of a user recognition method.

In operation 1110, a user recognition device extracts a user area of a current user from image data. Here, the user recognition device may correspond to the user recognition device 100 of FIG. 1, e.g., with operations of FIG. 11 corresponding to operations of the user feature extractor 110, user identifier estimator 120, and user data updater 130 of FIG. 1, though embodiments are not limited to the same.

In operation 1120, the user recognition device extracts a user feature of the current user from the user area. For example, the user recognition device may extract the user feature, for example, a face, clothing, a hairstyle, a body shape, and a gait of the current user, from the user area. In addition, the user recognition device may extract the user feature, for example, a voiceprint and a footstep of the current user, from audio data of the current user. The user features described herein are examples only. Embodiments may be varied and are not limited thereto.

In operation 1130, the user recognition device estimates an identifier of the current user based on the extracted user feature and prestored user data. For example, the user recognition device may determine a similarity between the current user and an existing user included in the user data based on the user feature extracted for the current user, and determine whether the current user corresponds to the existing user based on the determined similarity. The user recognition device may determine whether an existing user corresponding to the current user is present in the prestored user data. In response to absence of the existing user corresponding to the current user, the user recognition device may allocate to the current user a new identifier different from an identifier of the existing user. Additionally, in response to the presence of the existing user corresponding to the current user, the user recognition device may determine the identifier of the existing user to be the identifier of the current user.

In operation 1140, the user recognition device performs unsupervised learning or updates user data of the existing user included in the user data, based on a result of the estimating performed in operation 1130. In response to the absence of the existing user corresponding to the current user, the user recognition device may perform the unsupervised learning based on the user feature extracted for the current user and a user feature of the existing user. As a result of the unsupervised learning, the user data may be re-configured based on the new identifier allocated to the current user and identifiers of existing users in the user data.

In response to the presence of the existing user corresponding to the current user, the user recognition device may update the user data of the existing user corresponding to the current user based on the user feature extracted for the current user.

Any or any combination of the operations of FIGS. 2-11 may be implemented by the user recognition device 100 of FIG. 1, though embodiments are not limited to the same.

The user feature extractor 110, preprocessor 140, user identifier estimator 120, similarity determiner 150, mid-level feature determiner 160, user data updater 130, and unsupervised learning performer 170 in FIG. 1 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2-11 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, a vehicle, a smart car, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A user recognition method comprising:
extracting a user feature of a current user from input data;
estimating an identifier of the current user based on the extracted user feature; and
generating the identifier of the current user in response to an absence of an identifier corresponding to the current user and controlling an updating of user data based on the generated identifier and the extracted user feature.

2. The user recognition method of claim 1, wherein the estimating of the identifier of the current user comprises:
determining a similarity between the current user and an existing user included in the user data based on the extracted user feature; and
determining whether an identifier corresponding to the current user is present based on the determined similarity.

3. The user recognition method of claim 1, wherein the updating of the user data comprises:
performing unsupervised learning based on the extracted user feature and a user feature of an existing user included in the user data.

4. The user recognition method of claim 1, wherein the estimating of the identifier of the current user comprises:
determining a similarity between the current user and an existing user included in the user data based on the extracted user feature; and
allocating an identifier of the existing user to the current user in response to the determined similarity satisfying a preset condition, and
the updating of the user data comprises:
updating user data of the existing user based on the extracted user feature.

5. The user recognition method of claim 1, wherein the estimating of the identifier of the current user comprises:
determining a mid-level feature based on a plurality of user features extracted from input data for the current user; and
estimating the identifier of the current user based on the mid-level feature.

6. The user recognition method of claim 5, wherein the determining of the mid-level feature comprises:
combining the plurality of user features extracted for the current user and performing vectorization of images of the extracted user features to determine the mid-level feature.

7. The user recognition method of claim 5, wherein the determining of the mid-level feature comprises:
performing vectorization on the plurality of user features extracted for the current user based on a codeword generated from learning data to determine the mid-level feature.

8. The user recognition method of claim 5, wherein the estimating of the identifier of the current user based on the mid-level feature comprises:
determining a similarity between the current user and each existing user prestored in the user data based on the mid-level feature; and
determining an identifier, as the estimated identifier, of the current user to be an identifier of an existing user in response to the similarity being greater than or equal to a preset threshold value and being greatest among similarities of existing users.

9. The user recognition method of claim 5, wherein the estimating of the identifier of the current user based on the mid-level feature comprises:
determining a similarity between the current user and each existing user prestored in the user data based on the mid-level feature; and
allocating to the current user an identifier different from identifiers of existing users in response to each determined similarity being less than a preset threshold value.

10. The user recognition method of claim 1, wherein the estimating of the identifier of the current user comprises:
determining a similarity between the current user and an existing user included in the user data, with respect to each user feature extracted for the current user; and
estimating the identifier of the current user based on the determined similarity with respect to each extracted user feature.

11. The user recognition method of claim 10, wherein the estimating of the identifier of the current user based on the similarity determined with respect to each extracted user feature comprises:
determining a first similarity with respect to each extracted user feature between the current user and each of existing users included in the user data;
determining a second similarity between the current user and each of the existing users based on the first similarity determined with respect to each extracted user feature; and
determining an identifier of the current user, as the estimated identifier, to be an identifier of an existing user having a second similarity being greater than or equal to a preset threshold value and being greatest among second similarities of the existing users; or
allocating to the current user an identifier different from identifiers of the existing users in response to each of the second similarities of the existing users being less than the threshold value.

12. The use recognition method of claim 1, wherein the extracting of the user feature comprises:
respectively extracting any one or any combination of one or more of clothing, a hairstyle, a body shape, and a gait of the current user from image data, and/or extracting any one or any combination of one or more of a voiceprint and a footstep of the current user from audio data.

13. The user recognition method of claim 1, wherein the input data comprises at least one of image data and audio data, and
the extracting of the user feature comprises:
dividing at least one of the image data and the audio data for each user; and
extracting the user feature of the current user from at least one of the divided image data and the divided audio data.

14. The user recognition method of claim 1, wherein the extracting of the user feature of the current user comprises:
extracting a user area of the current user from image data; and
transforming the extracted user area into a different color model.

15. The user recognition method of claim 1, wherein the extracting of the user feature of the current user comprises:
extracting a patch area from a user area of the current user in image data;
extracting color information and shape information from the extracted patch area; and
determining a user feature associated with clothing of the current user based on the color information and the shape information.

16. The user recognition method of claim 1, wherein the extracting of the user feature of the current user comprises:
extracting a landmark associated with a body shape of the current user from image data;
determining a body shape feature distribution of the current user based on information on the surroundings of the extracted landmark; and
determining a user feature associated with the body shape of the current user based on the body shape feature distribution.

17. A non-transitory computer-readable storage medium storing instructions that, when executed by a processor, cause the processor to perform the method of claim 1.

18. A user recognition method comprising:
extracting a user area of a current user from image data;
extracting a user feature of the current user from the user area;
estimating an identifier of the current user based on the extracted user feature and prestored user data; and
performing unsupervised learning or updating of user data of an existing user included in the user data based on a result of the estimating.

19. The user recognition method of claim 18, wherein, in response to a determined absence of an existing user corresponding to the current user, the estimating of the identifier of the current user comprises:
allocating an identifier different from an identifier of the existing user to the current user, and
the performing of the unsupervised learning comprises:
performing the unsupervised learning based on the extracted user feature and a user feature of the existing user.

20. The user recognition method of claim 18, wherein, in response to presence of an existing user corresponding to the current user, the estimating of the identifier of the current user comprises:
determining an identifier of the existing user to be the identifier of the current user, and
the updating of the user data of the existing user comprises:
updating user data of the existing user corresponding to the current user based on the extracted user feature.

21. A user recognition device comprising:
a processor configured to:
extract a user feature of a current user from input data;
estimate an identifier of the current user based on the extracted user feature; and
generate an identifier of the current user in response to a determined absence of an identifier corresponding to the current user and update user data based on the generated identifier and the extracted user feature.

22. The user recognition device of claim 21, wherein the processor is further configured to determine a similarity between the current user and an existing user included in the user data based on the extracted user feature.

23. The user recognition device of claim 22, wherein the processor is further configured to control access or operation of the user recognition device based on a determined authorization process to access, operate, or interact with feature applications of the user recognition device, dependent on the determined similarity.
